(19) United States
(12) Patent Application Publication
(10) Pub. No.: US 2012/0260519 A1
(43) Pub. Date: Oct. 18, 2012

(54) CONTACT LENS CASE DRYING DISH

(76) Inventors: Dora SUMMA, Massapequa, NY (US); Richard Martin Summa, Massapequa, NY (US)

(21) Appl. No.: 13/085,982

(22) Filed: Apr. 13, 2011

(51) Int. Cl. F26B 19/00

(52) U.S. Cl. 34/427; 34/239

(57) ABSTRACT

A contact lens case drying apparatus and kit are provided. The apparatus includes a plate-like structure having an upper surface and a lower surface, said upper surface having at least one raised ridge that occupies a portion of a surface area of the upper surface of said plate-like structure, said ridge capable of supporting the contact lens case at a plurality of locations.

### TECHNICAL FIELD

The present disclosure generally relates to an apparatus for contact lens cases, and more particularly to a contact lens case drying apparatus and kit for the same.

### BACKGROUND

Contact lenses are widely used throughout the world. This modern replacement for bulky spectacles has revolutionized the eyeglass industry. Billions of dollars are spent annually on contact lenses and accessories.

Medically speaking, contact lenses require special care to prevent infections to the eye. Such infections can result in more serious medical conditions including blindness. Proper cleaning and handling of the contact lenses and accessories are required to prevent injury.

Contact lenses require regular cleaning and sterilization. The process is quite detailed in order to prevent any contamination. One recommended method of cleaning contact lenses requires the washing of one's hands with warm water and soap before handling the contact lenses or before touching one's eyes. Any residue from lotions, soaps, or chemicals may stick to the contact lens, causing pain, irritation, or blurred vision when they are in one's eyes. Hands should be dried with a clean towel. The contact lenses are to be cleaned and stored as prescribed (in a clean case in fresh solution). Different types of contact lenses require special care and certain types of products. The contact lens case should be cleaned after each use with either sterile solution or hot tap water and allowed to air dry. Saline solution is recommended for rinsing and storing contact lenses. Enzymatic cleaning tablets or cleaning/disinfecting devices may also be employed. Daily cleaning is recommended for contact lenses. Contact lenses should be cleaned with daily cleaner, rinsed (as directed) and disinfected. When ready to wear the contact lenses should be again rinsed. As can be seen, great care is required to properly clean and disinfect contact lenses. The same care is required for contact lens cases.

As with contact lenses, contact lens cases must be clean and sterile to avoid the risk of infection after each use. Data indicates that lens cases are a significant source of microbial contamination. Therefore, proper lens case cleaning is essential for minimizing the risk of contact lens related eye infections. Special care instructions for contact lens cases can include the following procedures: wash and dry hands thoroughly by using a mild hand soap and warm water. All soap residue should be rinsed away and touching any lotions or oils until after finished cleaning the contact lens case should be avoided. Contact lenses are to be removed from the case. The contact lens case should be emptied of any remaining solution. The contact lens case and covers should be rinsed in hot running water; the hottest water possible is recommended, as this will help destroy any bacteria as well as help rinse away any grime. The contact lens case and covers can be scrubbed with a clean, unused toothbrush, hot water and soap, or other cleaning solution. Whichever cleaning method is used, manufacturer recommended cleaning should be followed. The entire case, including the outside, top, and bottom should be scrubbed (this will help prevent transference of dirt to the area where the lenses are). Special attention should be afforded to the threads of the caps if the case has screw-on covers. The contact lens case should be thoroughly rinsed to remove any traces of soap. The contact lens case can be dried with a lint-free towel. If there are any traces of water that can't be removed this way, the contact lens case should be air dried before filling it with storing solution.

Usually, the contact lens case is air dried by being placed on a tissue, towel, or other soft surface. This process can contribute to contamination by bacteria and other foreign objects that may be present on the surface of the tissue, towel, etc. Thus, even though great care may have been taken in the cleaning and sterilization of the contact lenses and contact lens case, the final step of air drying the case may negate the entire cleaning and sterilization processes.

### SUMMARY OF THE INVENTION

Accordingly, the present invention has been made to solve at least the above-mentioned problems occurring in the prior art, and an object of the present invention is to provide a contact lens case drying apparatus and kit thereof.

In one embodiment, in accordance with the principles of the present disclosure, a contact lens case drying apparatus is provided. The apparatus includes a plate-like structure having an upper surface and a lower surface, said upper surface having at least one raised ridge that occupies a portion of a surface area of the upper surface of said plate-like structure, said ridge capable of supporting the contact lens case at a plurality of locations.

In yet another embodiment, in accordance with the principles of the present disclosure, a contact lens case drying kit is provided. The kit includes a plate-like structure having an upper surface and a lower surface, said upper surface having at least one raised ridge that occupies a portion of a surface area of the upper surface of said plate-like structure, said ridge capable of supporting the contact lens case at a plurality of locations, a tray coupled to said lower surface of said plate-like structure and capable of collecting fluid that drains from said upper surface through said drainage opening, and a plurality of absorbent pads.

In yet another embodiment, in accordance with the principles of the present disclosure, a method for drying a contact lens case is provided. The method includes placing a contact lens case on a plate-like structure having an upper surface and a lower surface, said upper surface having at least one raised ridge that occupies a portion of a surface area of the upper surface of said plate-like structure, said ridge capable of supporting the contact lens case at a plurality of locations.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view of a contact lens case drying apparatus according to an embodiment of the present invention;

FIG. 2 is a perspective view of a contact lens case;

FIG. 3 is a perspective view of a contact lens case drying apparatus with a contact lens case situated thereon;

FIG. 4 is a top view of a contact lens case drying apparatus according to an embodiment of the present invention;

FIG. 5 is a side view of a contact lens case drying apparatus according to an embodiment of the present invention;

FIG. 6 is a cross sectional view of a contact lens case drying apparatus according to an embodiment of the present invention;

FIG. 7 is a top view of a contact lens case drying apparatus according to an embodiment of the present invention;

FIG. 8 is a side view of a contact lens case drying apparatus according to an embodiment of the present invention;

FIG. 9 is a cross sectional view of a contact lens case drying apparatus according to an embodiment of the present invention;

FIG. 10 is a bottom view of an upper plate according to an embodiment of the present invention;

FIG. 11 is a top view of a pad tray according to an embodiment of the present invention;

FIG. 12 is a side view of a contact lens case drying apparatus according to an embodiment of the present invention;

FIG. 13 is a cross sectional view of a contact lens case drying apparatus according to an embodiment of the present invention;

FIG. 14 is a top view of a contact lens case drying apparatus according to an embodiment of the present invention;

FIG. 15 is a side view of a contact lens case drying apparatus according to an embodiment of the present invention;

FIG. 16 is a cross sectional view of a contact lens case drying apparatus according to an embodiment of the present invention;

FIG. 17 is a perspective view of a contact lens case drying apparatus according to an embodiment of the present invention;

FIG. 18 is a top view of a contact lens case drying apparatus according to an embodiment of the present invention;

FIG. 19 is a cross sectional view of a contact lens case drying apparatus along line A of FIG. 18;

FIG. 20 is a cross sectional view of a contact lens case drying apparatus along line B of FIG. 18;

FIG. 21 is a top view of a contact lens case drying apparatus according to an embodiment of the present invention;

FIG. 22 is a cross sectional view of a contact lens case drying apparatus of FIG. 18;

FIG. 23 is a cross sectional view of a contact lens case drying apparatus of FIG. 18;

FIG. 24 is a top view of a hinged embodiment of contact lens case drying apparatus according to an embodiment of the present invention;

FIG. 25 is a cross sectional view of a contact lens case drying apparatus of FIG. 24;

FIG. 26 is a cross sectional view of a contact lens case drying apparatus of FIG. 24;

FIG. 27 is a top view of a contact lens case drying apparatus containing an ultraviolet (UV) lamp according to an embodiment of the present invention;

FIG. 28 is a side view of a contact lens case drying apparatus of FIG. 27; and

FIG. 29 is a cross sectional view of a contact lens case drying apparatus of FIG. 27.

Like reference numerals indicate similar parts throughout the figures.

### DETAILED DESCRIPTION OF THE PREFERRED EMBODIMENTS

A preferred embodiment of the present invention will be described in detail with reference to the accompanying drawings. Note that the same or similar components in drawings are designated by the same reference numerals as far as possible although they are shown in different drawings. In the following description of the present invention, a detailed description of known functions and configurations incorporated herein will be omitted when it may make the subject matter of the present invention rather unclear.

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

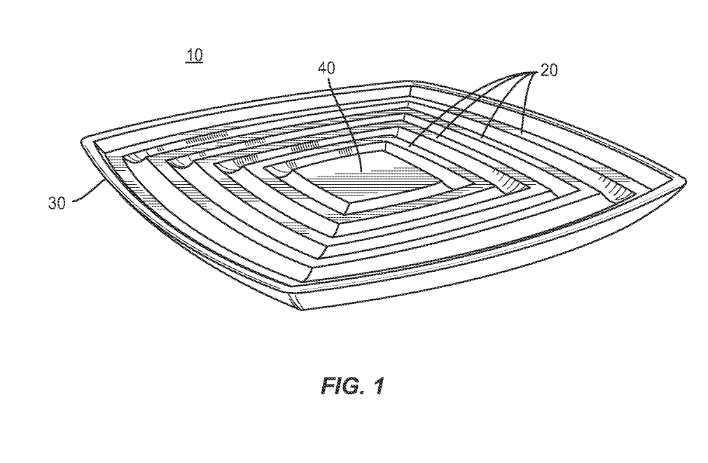

The following discussion includes a description of a contact lens case drying apparatus and kit thereof in accordance with the principles of the present disclosure. Alternate embodiments are also disclosed. Reference will now be made in detail to the exemplary embodiments of the present disclosure, which are illustrated in the accompanying figures. Turning now to FIGS. 1-xx, there are illustrated a contact lens case drying apparatus and kit thereof in accordance with the principles of the present disclosure.

A contact lens case drying apparatus 10 according to an embodiment is shown. The contact lens case drying apparatus 10 is a plate-like structure that includes a plurality of ridges 20 and an outer edge 30. A center ridge 40 can be included if the plurality of ridges 20 do not completely fill the area defined by the outer edge 30. In another embodiment, a single coil shaped ridge can replace the plurality of concentric ridges 20 shown in FIG. 1. Although the contact lens case drying apparatus 10 is shown having a square shape, other shapes are contemplated, for example, a circle or an oval shape are also contemplated.

In a preferred embodiment of the present invention the ridges 20 are ⅛ of an inch in width, and spaced 3/16 of an inch apart. In a preferred embodiment, the height of a given ridge 20, as measured from the bottom of the groove created by and between the ridges 20, is 1/16 of an inch. Although these preferred dimensions are disclosed, the width, spacing and height of the ridges 20 can vary in range.

Contact lens case drying apparatus 10 can preferably be manufactured from materials that are easily sterilized, dishwasher safe and/or capable of being boiled in water. Also, it is preferable that the contact lens case drying apparatus 10 be manufactured from material having antibacterial properties that can resist easy contamination. These materials provide for a sanitary place to dry and store a contact lens case. For example, a natural-based polymer can be used to provide a natural and renewable resource. A kiln-dried ceramic is also contemplated as this material is resistant to bacteria and can be easily disinfected. In addition these materials can be anti-microbial in nature. Other variations include non-toxic, recyclable, eco-friendly materials. These materials can prevent the growth of microorganisms such as bacteria, fungi or protozoans.

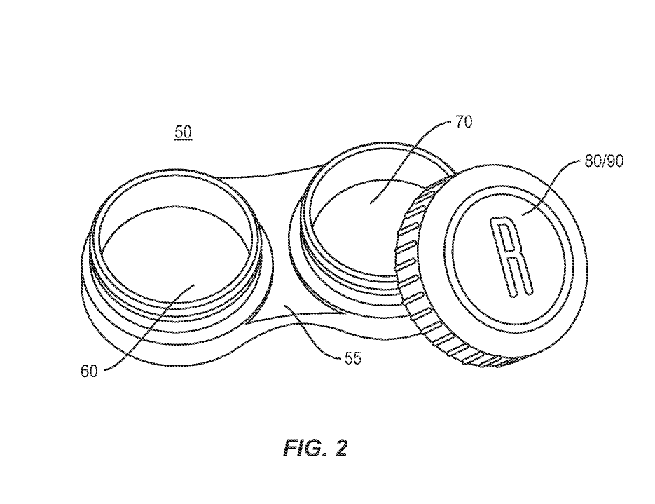

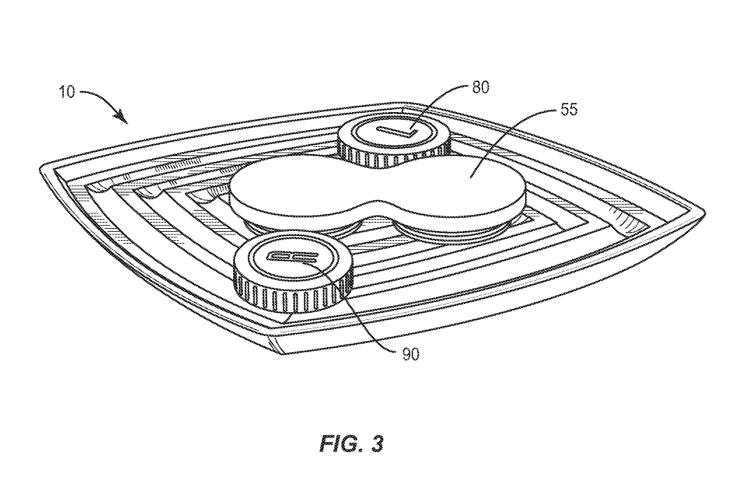

A standard contact lens case 50 generally includes a base unit 55 having two attached lens receptacles 60/70. The lens receptacles 60/70 generally include covers 80/90 and means for securing covers 80/90 to lens receptacles 60/70. The means for securing the covers 80/90 to the receptacles 60/70 can include threads to screw the covers 80/90 to the receptacles 60/70; other means are contemplated. The overall size of the contact lens case 50 defines a minimum size for the contact lens case drying apparatus 10. For example, a standard contact lens case 50 might be 3 inches in length and 1 inch in width, thus the area defined by outer edge 30 of contact lens case drying apparatus 10 must be at least large enough to fully accommodate the contact lens case. Preferably, the area defined by outer edge 30 of contact lens case drying apparatus 10 should be large enough to accommodate both the base unit 55 and covers 80/90 as shown in FIG. 3.

After base unit 55 and/or covers 80/90 are cleaned and sterilized, they are placed on contact lens case drying apparatus 10 with the open ends of the receptacles 60/70 and the covers 80/90 down to air dry. Base unit 55 and/or covers 80/90 rest on top of ridges 20. To prevent excessive contact between the base unit 55 and/or covers 80/90 and the ridges 20 and thus also further reduce any possibility of contamination, the ridges 20 can have top surfaces that are convex or pointed in shape. The ridges 20 allow air to circulate about the base unit 55 and/or covers 80/90 and allow water to drip from the base unit 55 and/or covers 80/90 into the groves formed by and between the ridges 20.

In another embodiment of the present invention, the contact lens case drying apparatus 100 includes a drainage system to assist in the drying process.

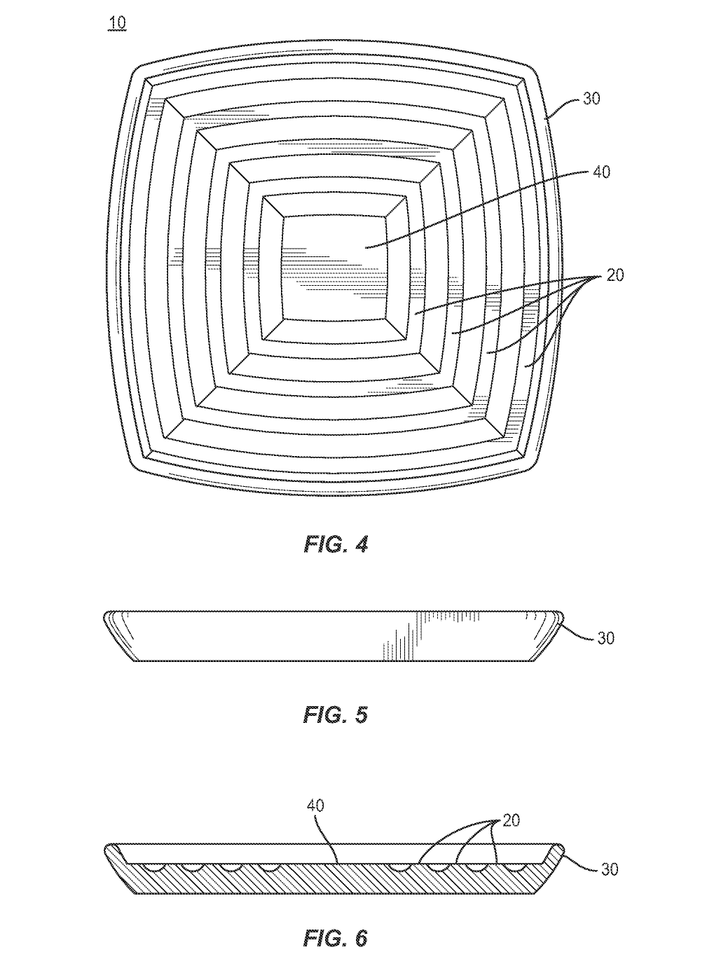

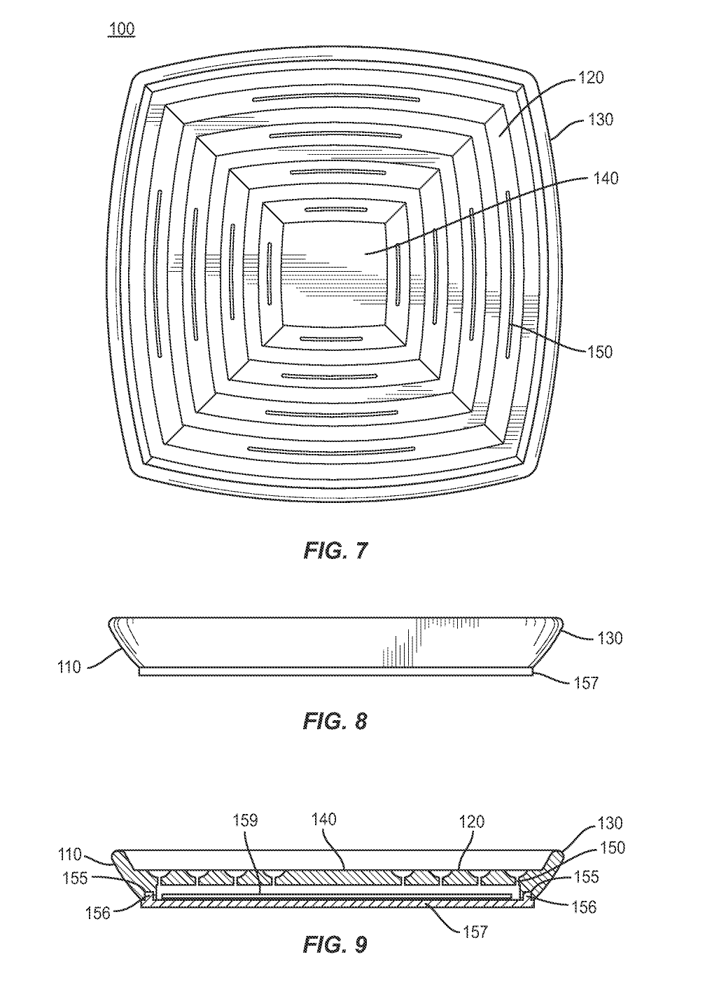

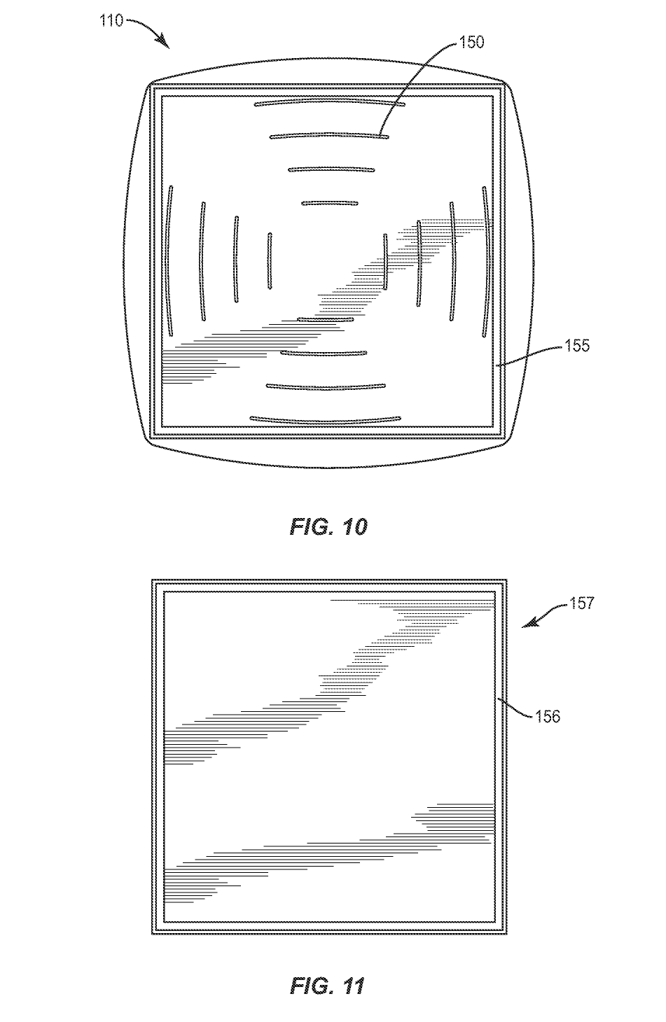

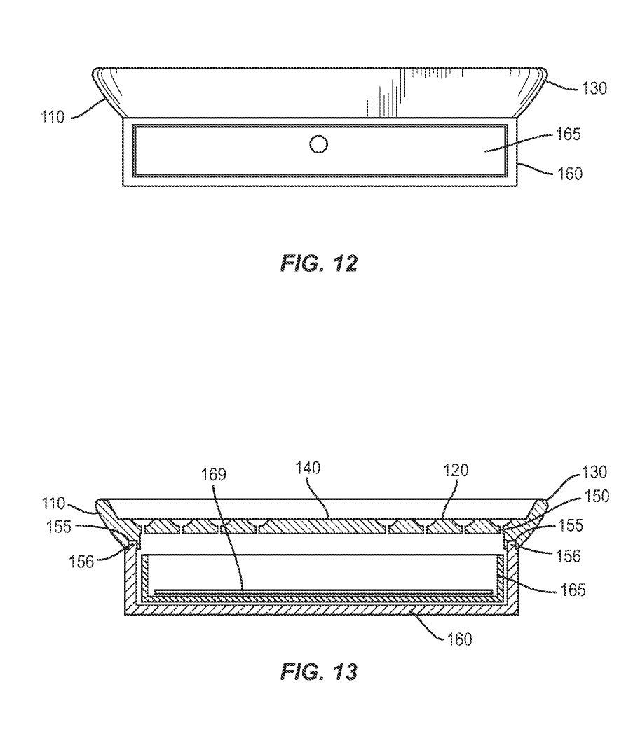

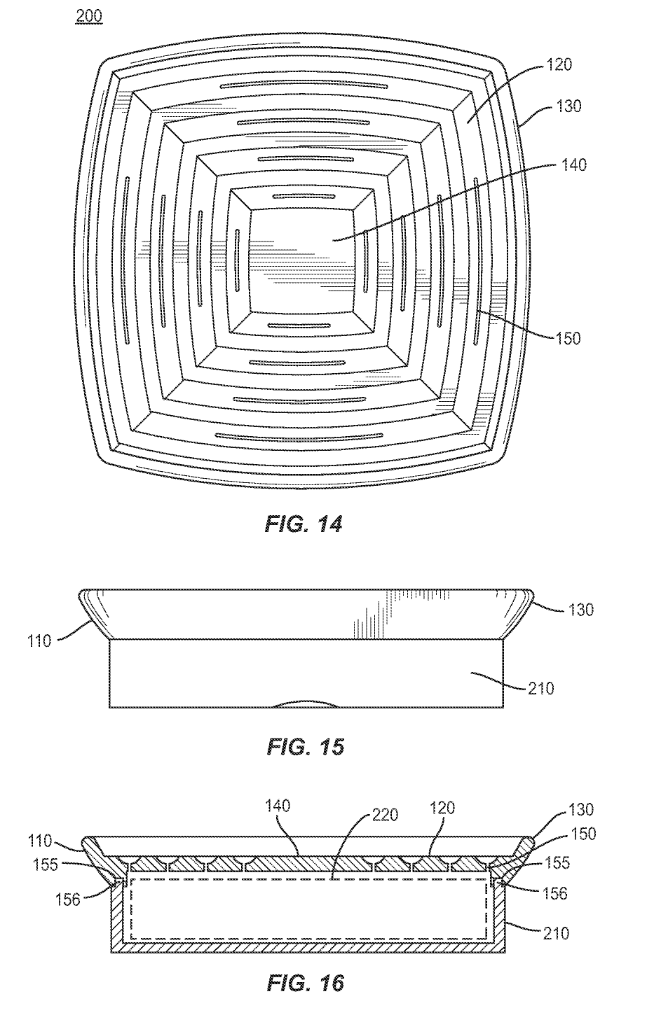

Contact lens case drying apparatus 100 shown in FIGS. 7-9 is similar to contact lens case drying apparatus 10 shown in FIGS. 4-6 with respect to ridges 120 and ridges 20, respectively, and outer edge 130 and outer edge 30, respectively.

Contact lens case drying apparatus 100 includes drainage openings 150. Drainage openings 150 are shown as slots that run along the grooves between ridges 120 and extend downward and through contact lens case drying apparatus 100 as shown in FIG. 9. Drainage openings 150 are not limited to slots, but can also be implemented as holes or other shaped openings. The drainage openings 150 allow for excess water that drips from contact lens case 50 to drain down and away from contact lens case 50 and not pool in the grooves that are formed by and between the ridges 120. The drainage system furthers the drying process and removes water subject to contamination away from the contact lens case 50.

In addition to the drainage openings 150, the drainage system of contact lens case drying apparatus 100 can also include pad tray 157 and drying pad 159. In this embodiment, contact lens case drying apparatus 100 includes upper plate 110, pad tray 157 and drying pad 159. Upper plate 110 is similar to the contact lens case drying apparatus 10, but also includes drainage openings 150 and a coupling system to couple upper plate 110 to pad tray 157.

In one embodiment, the coupling system to couple upper plate 110 to pad tray 157 includes a slot 155 and a ridge 156. Slot 155 is shown running along the bottom of upper plate 110 and ridge 156 is shown running along the top of pay tray 157. Although slot 155 and ridge 156 are shown running along all edges of upper plate 110 and pad tray 157, respectively, slot 155 and ridge 156 can be discontinuous as long as slot 155 can mate with ridge 156. Another coupling system to couple upper plate 110 to pad tray 157 can include a pin and hole system; other coupling systems are contemplated. The coupling system can be designed such that slot 155 and ridge 156 loosely fit together or produce a friction fit when mated that would removably attach upper plate 110 to pad tray 157. Annular, cantilever, and torsional snap fits to couple upper plate 110 to pad tray 157 are also contemplated.

Pad 159 can be placed on pad tray 157 within the bounds of ridge 156 and can collect water that drains through drainage system, e.g. drainage openings 150, to prevent pooling of water. Pad 159 can be manufactured from an absorbent material, and can be reusable or disposable.

In another embodiment of the present invention, pad tray 160 is increased in its vertical dimension to accommodate pad drawer 165. One side of pad tray 160 can be open to accommodate pad drawer 165. When pad tray 160 is coupled to upper tray 110, pad drawer 165 can slide in and out of pad tray 160. Drying pad 169 can be placed in the bottom of pad drawer 165, which is slid into pad tray 160, and collect water dripping from contact lens case 50 through drainage openings 150 to prevent pooling of water.

In yet another embodiment of the present invention, the contact lens case drying apparatus 200 includes an air circulation system to assist in the drying process. The air circulation system can include a fan housing 210 and a fan 220. Fan 220 is located within fan housing 210. Fan housing 210 is capable of being coupled to upper plate 110 using coupling systems similar to those discussed above. In a preferred embodiment, fan 220 is operated to draw air in a downward direction A through drainage openings 150, fan housing 210 and out vents 230 in direction B. This movement of air will decrease the time required to dry contact lens case 50, thus reducing the time contact lens case 50 is exposed to possible contamination. An opposite air flow direction is also possible to draw air in through vents 230 and upward through drainage openings 150.

Various embodiments of the air circulation system for the contact lens case drying apparatus 200 are contemplated. For example, an alternating current (AC) design is contemplated wherein fan 220 receives its power from a standard AC source. In another design, the air circulation system for the contact lens case drying apparatus 200 can receive power from a battery contained in the fan housing 210. The battery can be disposable or rechargeable. The rechargeable battery can be recharged through AC power or solar cell technology.

In yet another embodiment of the present invention, the contact lens case drying apparatus includes a lighting system. For example, in one embodiment the fan can be replaced with a small light that can act as a night light for the user. The material used to manufacture the light housing and/or the upper 110 can be of a translucent material to allow light to pass through and to the outside. The night light design can be powered by AC power or batteries depending on design.

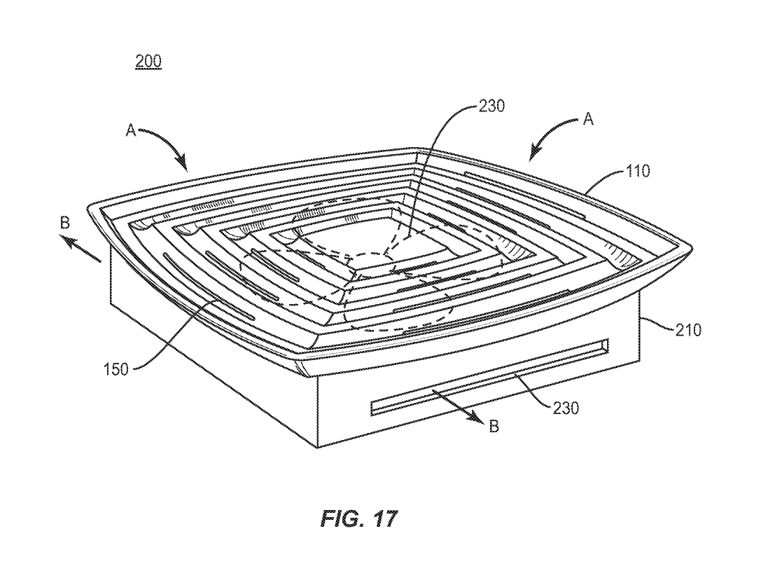

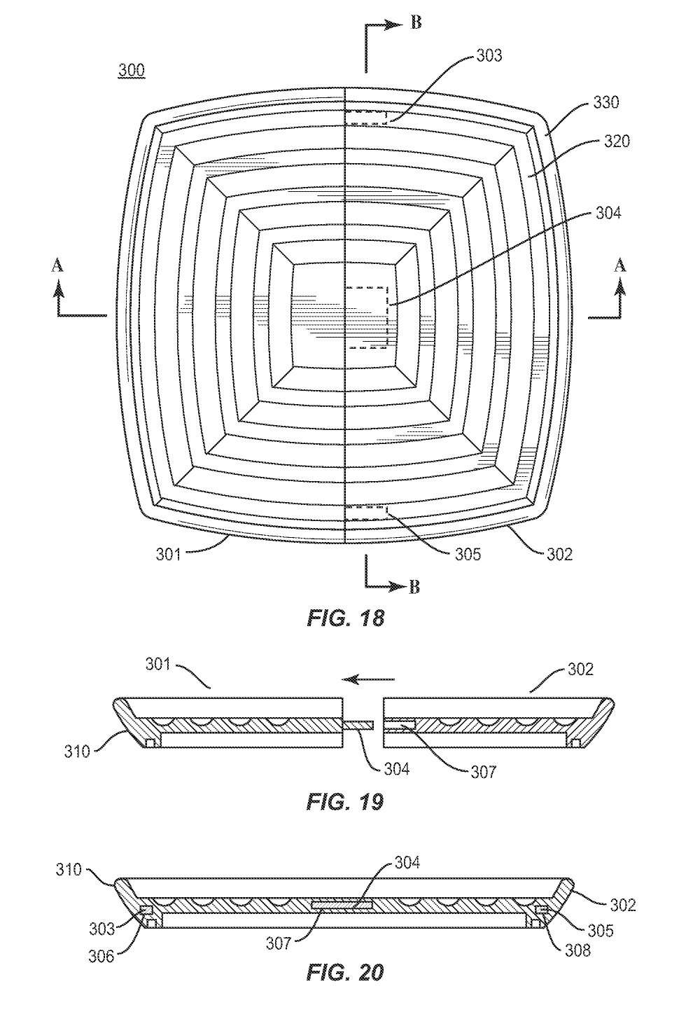

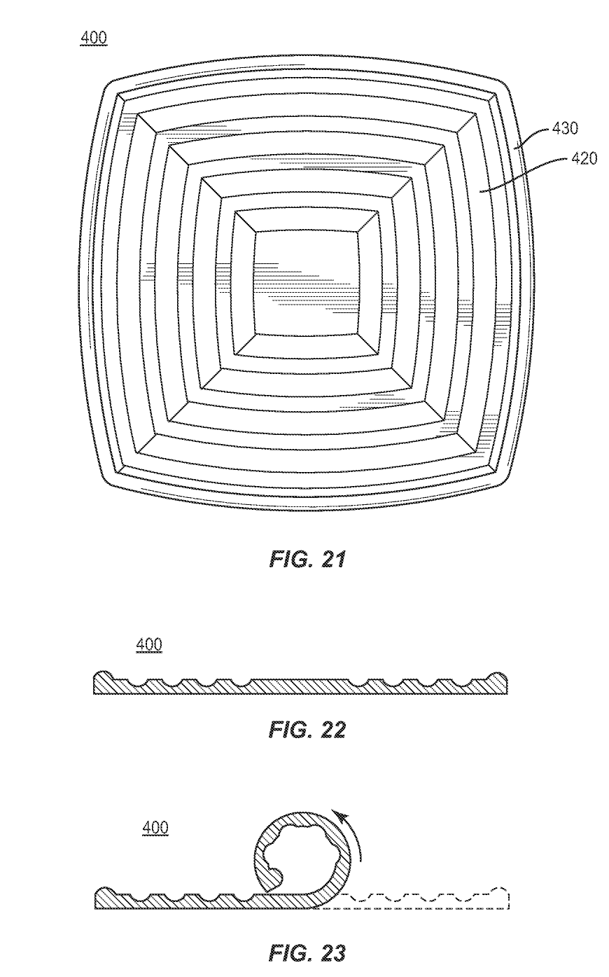

In another embodiment of the present invention, the contact lens case drying apparatus 300 is designed to be more portable than a rigid, one-piece, upper plate structure. One version of a portable contact lens case drying apparatus 300 includes upper plate 310. Upper plate 310 is divided into 2 parts: a first part 301 and a second part 302. The first part 301 and the second part 302 are designed to mate with each other. One mating design consists of a tongue and groove. The first part 301 can include tabs 303-305 that mate with slots 306-308, respectively. In this embodiment the upper plate 310 can be separated into its first part 301 and its second part 302 for easy storage and compact travel. Although not shown in FIGS. 18-20, the contact lens case drying apparatus 300 can include drainage openings to further facilitate the drying process.

In yet another embodiment of the present invention, contact lens case drying apparatus 400 can be fabricated from a flexible material. The flexible material allows the contact lens case drying apparatus 400 to be rolled up for compact storage and/or carrying. The flexible material can be resistant to bacterial contamination. In its rolled up state the contact lens case drying apparatus 400 can be placed into a pouch or tube for convenient travel or storage.

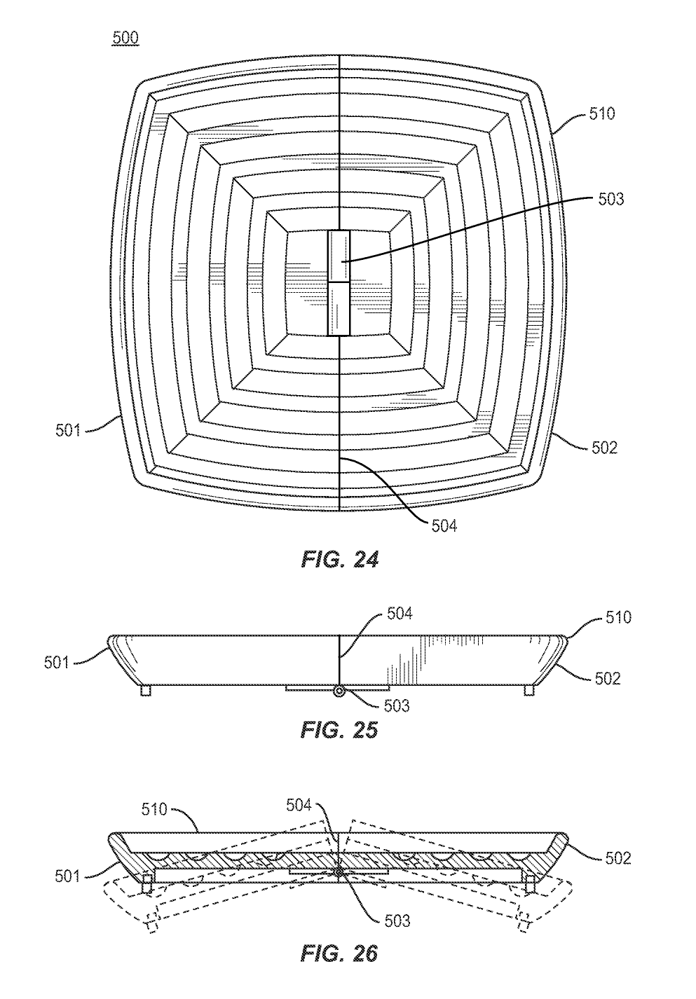

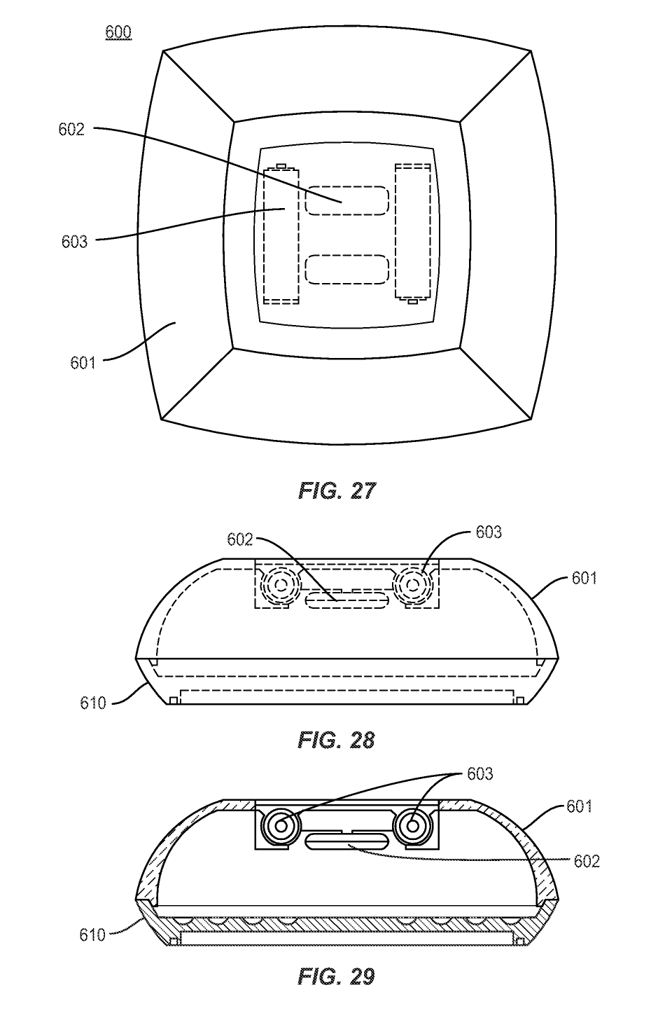

In another embodiment of the present invention, the contact lens case drying apparatus 500 is designed to be more portable than a rigid, one-piece, upper plate structure. One version of a portable contact lens case drying apparatus 500 includes upper plate 510. Upper plate 510 is divided into 2 parts: a first part 501 and a second part 502. The first part 501 and the second part 502 are connected via hinge 503. In this embodiment the upper plate 510 can be separated into its first part 501 and its second part 502 via hinge 503 for easy storage and compact travel. Although not shown in FIGS. 24-26, the contact lens case drying apparatus 500 can include drainage openings to further facilitate the drying process.

In still yet another embodiment of the present invention, the contact lens case drying apparatus 600 can include a lamp cover 601 containing a ultraviolet (UV) lamp 602 to further assist in the cleaning and sanitization processes. The lamp cover 601 can be positioned on said upper surface of said plate-like structure 610. The UV lamp 602 is positioned within said lamp cover 601 and connects to a power source 603. The power source 603 can be an alternating current power source or a battery (as shown). In addition, the lamp cover 601 can be manufactured from a translucent material to allow for light emitted from the UV lamp to radiate out and provide a soft glow when operating.

In yet another embodiment, a contact lens case drying apparatus as well as a plurality of disposable pads may be packaged as a system or kit. In such an embodiment, the kit may include an upper plate, pad tray and a plurality of pads.

In yet another embodiment, the contact lens case drying apparatus can be disposable. The contact lens case drying apparatus can be manufactured from a biodegradable material and discarded after one or a few uses.

In yet another embodiment, a method for drying a contact lens case is provided. The method includes placing a contact lens case on a plate-like structure having an upper surface and a lower surface, said upper surface having at least one raised ridge that occupies a portion of a surface area of the upper surface of said plate-like structure, said ridge capable of supporting the contact lens case at a plurality of locations.

Further embodiments are contemplated. For example, a non-skid surface can be applied to the bottom of the contact lens case drying apparatus to prevent the apparatus from sliding on a smooth surface. The non-skid surface can include pads that prevent slipping, for example one or more rubber pads.

The contact lens case drying apparatus of the present invention can decrease the drying time of a contact lens case and provide a sterile and healthy location to conduct the drying process.

Although various embodiments have been disclosed, other embodiments are contemplated. It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A contact lens case drying apparatus, comprising:
a plate-like structure having an upper surface and a lower surface, said upper surface having at least one raised ridge that occupies a portion of a surface area of the upper surface of said plate-like structure, said ridge capable of supporting the contact lens case at a plurality of locations.

2. The contact lens case drying apparatus of claim 1, wherein said at least one raised ridge is one of a plurality of concentric ridges or a single spiral ridge.

3. The contact lens case drying apparatus of claim 1, further comprising at least one drainage opening through said upper and lower surfaces and positioned in grooves formed by and between said at least one ridge.

4. The contact lens case drying apparatus of claim 3, further comprising a tray coupled to said lower surface of said plate-like structure and capable of collecting fluid that drains from said upper surface through said drainage opening.

5. The contact lens case drying apparatus of claim 4, further comprising an absorbent pad contained in said tray for absorbing said fluid that drains from said upper surface through said drainage opening.

6. The contact lens case drying apparatus of claim 4, wherein said tray is coupled to said plate-like structure by one of annular, cantilever, and torsional snap fits.

7. The contact lens case drying apparatus of claim 3, further comprising:
a drawer tray coupled to said lower surface of said plate-like structure; and
a drawer slidably coupled with said drawer tray and capable of collecting fluid that drains from said upper surface through said drainage opening.

8. The contact lens case drying apparatus of claim 7, further comprising an absorbent pad contained in said drawer for absorbing said fluid that drains from said upper surface through said drainage opening.

9. The contact lens case drying apparatus of claim 7, wherein said drawer tray is coupled to said plate-like structure by one of annular, cantilever, and torsional snap fits.

10. The contact lens case drying apparatus of claim 3, further comprising:
a fan housing coupled to said lower surface of said plate-like structure and including air vents thereon; and
an electric fan connectable to a power source and positioned within said fan housing for drawing air downward through said drainage opening and through said air vents.

11. The contact lens case drying apparatus of claim 10, wherein said fan housing is coupled to said plate-like structure by one of annular, cantilever, and torsional snap fits.

12. The contact lens case drying apparatus of claim 10, wherein said power source is one of an alternating current power source or a battery.

13. The contact lens case drying apparatus of claim 3, further comprising:
a fan housing coupled to said lower surface of said plate-like structure and including air vents thereon; and
an electric fan connectable to a power source and positioned within said fan housing for drawing air in through said air vents and upward through said drainage opening.

14. The contact lens case drying apparatus of claim 13, wherein said fan housing is coupled with said plate-like structure by one of annular, cantilever, and torsional snap fits.

15. The contact lens case drying apparatus of claim 13, wherein said power source is one of an alternating current power source or a battery.

16. The contact lens case drying apparatus of claim 1, further comprising:
a light housing coupled to said lower surface of said plate-like structure; and
an electric light position within said light housing and connectable to a power source.

17. The contact lens case drying apparatus of claim 16, wherein said power source is one of an alternating current power source or a battery.

18. The contact lens case drying apparatus of claim 16, wherein said light housing and/or said plate-like structure are manufactured from a translucent material.

19. The contact lens case drying apparatus of claim 1, wherein the plate-like structure is manufactured from a material resistant to bacterial contamination.

20. The contact lens case drying apparatus of claim 19, wherein the material is one of a natural based polymer and a ceramic.

21. The contact lens case drying apparatus of claim 1, wherein the surface area of the plate-like structure is large enough to accommodate a contact lens case and two covers.

22. The contact lens case drying apparatus of claim 1, wherein the plate-like structure is manufactured from a flexible material.

23. The contact lens case drying apparatus of claim 22, wherein the flexible material is resistant to bacterial contamination.

24. The contact lens case drying apparatus of claim 1, wherein the plate-like structure comprises:
a first part; and
a second part connectable to said first part,
wherein said first part and said second part form said plate-like structure when connected.

25. The contact lens case drying apparatus of claim 1, further comprising:
a lamp cover positionable on said upper surface of said plate-like structure; and
an ultraviolet (UV) lamp position within said lamp cover and connectable to a power source.

26. The contact lens case drying apparatus of claim 16, wherein said power source is one of an alternating current power source or a battery.

27. The contact lens case drying apparatus of claim 25, wherein said lamp cover is manufactured from a translucent material.

28. The contact lens case drying apparatus of claim 1, wherein the plate-like structure comprises:
a first part;
a second part; and
a hinge connecting said first part to said second part,
wherein said first part and said second part form said plate-like structure when opened about said hinge and folds approximately in half about said hinge.

29. The contact lens case drying apparatus of claim 1, wherein the plate-like structure is manufactured from biodegradable material.

30. The contact lens case drying apparatus of claim 1, wherein the lower surface of the plate-like structure includes a non-skid surface.

31. A method for drying a contact lens case, comprising placing a contact lens case on a structure according to claim 1

32. A kit for drying a contact lens case, comprising:
the contact lens case drying apparatus of claim 4; and
a plurality of absorbent pads configured to fit within said tray.
